(19) United States
(12) Patent Application Publication
(10) Pub. No.: US 2006/0217108 A1
(43) Pub. Date: Sep. 28, 2006

(54) Network authentication apparatus, network authentication method, network authentication system, and network authentication program

(75) Inventor: Tatsuya Ishii, Tokyo (JP)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(73) Assignee: NEC Corporation

(21) Appl. No.: 11/089,502

(22) Filed: Mar. 25, 2005

(51) Int. Cl. H04M 1/66

(52) U.S. Cl. 455/411; 713/167

(57) ABSTRACT

A network authentication apparatus includes a cellular phone connection unit and IT terminal device. The cellular phone connection unit includes a fitting portion in/from which a cellular phone can be inserted/removed. The IT terminal device is connected to the cellular phone connection unit, includes a memory, and is connected to a digital network. The IT terminal device reads out device attribute information containing individual identification information of a cellular phone from the cellular phone connected to the cellular phone connection unit, and sends out the readout device attribute information as authentication information to the digital network. A network authentication method, network authentication program, and network authentication system are also disclosed.

### BACKGROUND OF THE INVENTION

The present invention relates to a network authentication apparatus, network authentication method, network authentication system, and network authentication program which perform authentication for wide area network connection at a Hotspot (R) or the like by using a cellular phone.

A cellular phone has a data communication function in addition to a voice communication function, and can connect to the Internet. The advent of so-called third-generation cellular phones has increased the communication speed as well as improving the quality of voice communication. Cellular phones are compact and exhibit good portability, and hence have recently spread as portable terminal devices which can connect to a network such as the Internet (see, for example, Japanese Patent Laid-Open Nos. 2001-211114, 2003-256641, and 2003-331928). As portable terminal devices mainly used for data communication, compact computer devices such a PDA (Personal Data Assistance) and the like have been used (see Japanese Patent Laid-Open Nos. 10-178500 and 2002-320274). Cellular phones are superior in portability than portable terminal devices.

When, however, a cellular phone is to be connected to the Internet, the line speed is lower than that in wire broadband connection by means of ADSL or optical fiber. In addition, Internet connection is unstable because of radio connection. Furthermore, a cellular phone is very compact in consideration of portability, and is partly inferior in operability to a compact computer device such as a so-called notebook computer, because there are limitations on the size of a display unit and the input environment. There is available a system which realize Internet connection by using a compact computer device as a terminal and a radio LAN access point such as a Hotspot (R). This system, however, poses a problem in terms of portability.

### SUMMARY OF THE INVENTION

It is, therefore, a main object of the present invention to provide a network authentication apparatus, network authentication method, network authentication system, and network authentication program which, when a cellular phone which is convenient to be carried around is connected to a digital network such as a the Internet or a LAN, can send the authentication information of the connected cellular phone to the network.

In order to achieve the above object, according to the present invention, there is provided a network authentication apparatus comprising a cellular phone connection unit which includes a fitting portion in/from which a cellular phone can be inserted/removed, and an IT terminal device which is connected to the cellular phone connection unit, includes a memory, and is connected to a digital network, wherein the IT terminal device reads out device attribute information containing individual identification information of a cellular phone from the cellular phone connected to the cellular phone connection unit, and sends out the readout device attribute information as authentication information to the digital network.

### BRIEF DESCRIPTION OF THE DRAWINGS

FIG. 1 is a view showing an example of the arrangement of a network authentication system using a network authentication apparatus according to the present invention;

FIG. 1A is a block diagram showing an example of an IT spot terminal device in FIG. 1;

FIG. 2 is a flowchart for explaining an example of the operation of the network authentication system shown in FIG. 1;

FIG. 3 is a flowchart for explaining another example of the operation of the network authentication system shown in FIG. 1;

FIG. 4 is a flowchart for explaining still another example of the operation of the network authentication system shown in FIG. 1;

FIG. 5 is a view showing another example of the arrangement of the network authentication system according to the present invention; and

FIG. 6 is a view showing still another example of the arrangement of the network authentication system according to the present invention.

### DESCRIPTION OF THE PREFERRED EMBODIMENT

An embodiment of the present invention will be described below with reference to the accompanying drawings.

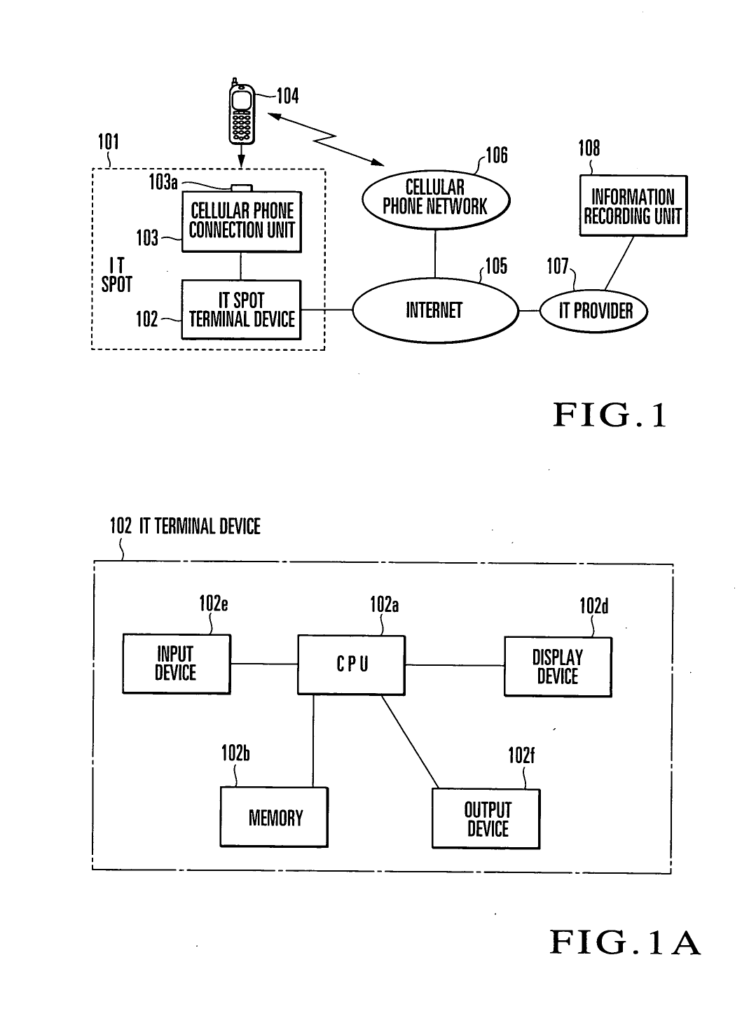

FIG. 1 shows an example of the arrangement of a network authentication system using a network authentication apparatus according to the present invention. This system comprises an IT spot terminal device 102 installed at an IT spot 101, a cellular phone connection unit 103 connected to the IT spot terminal device 102, a cellular phone 104, Internet 105 to which the IT spot terminal device 102 is connected, a cellular phone network 106 connected to the Internet 105, and an IT provider 107 connected to the Internet 105.

The IT spot 101 is a space where Internet connection services are provided for an unspecified number of users by the IT spot terminal device 102. The IT spot terminal device 102 is directly connected to the Internet 105 in the form of ADSL, optical fiber connection, or the like. As shown in FIG. 1A, the IT spot terminal device 102 is a computer device comprising a CPU 102a, a memory 103b, a display device 102d such as a display, an input device 102e such as a keyboard or mouse, and a voice output device 102f such as a speaker, and has high operability.

The cellular phone connection unit 103 has a fitting portion 103a in/from which the cellular phone 104 can be inserted/removed, and is capable of transmitting/receiving information to/from the cellular phone 104 mounted in the fitting portion 103a. For example, the cellular phone connection unit 103 reads device attribute information unique to the cellular phone 104 from the cellular phone 104 mounted in the fitting portion 103a. The device attribute information is information containing an individual identifier such as a telephone number or serial number assigned to the cellular phone 104. The cellular phone connection unit 103 also has a charging function of charging a secondary battery housed in the cellular phone 104.

The cellular phone 104 incorporates a storage unit (not shown) and stores data (information) received through the cellular phone connection unit 103 in the storage unit. In addition, the storage unit stores identifier information containing an identifier set by a user and the like, together with device attribute information. The cellular phone 104 has a telephone function of performing voice communication, an information communication function based on an Internet protocol, a browser function for browsing Web pages upon connection to the Internet 105, and the like.

The IT provider 107 is connected to the Internet 105 and has a LAN (Local Area Network) inside and an information recording unit 108 connected to the IT provider 107 through the LAN. A personal database comprising information of a target user for which Internet connection services are provided, e.g., setting information, personal files, e-mail, and the like, is recorded on the information recording unit 108. The IT provider 107 performs authentication of a connection request from the IT spot terminal device 102 by referring to the personal database prepared in the information recording unit 108.

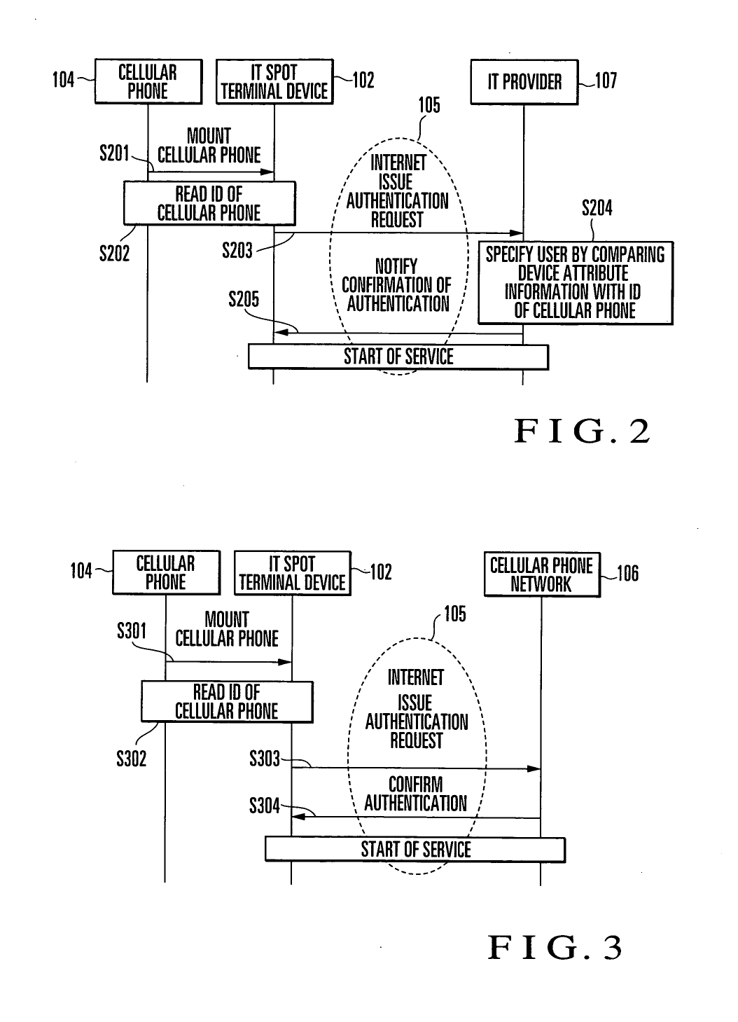

An example of the operation of the network authentication system shown in FIG. 1 will be described next with reference to the flowchart of FIG. 2.

First of all, when the user who owns the cellular phone 104 inserts the cellular phone 104 in the fitting portion 103a of the cellular phone connection unit 103 (step S201), the cellular phone connection unit 103 reads device attribute information from the mounted cellular phone 104 (step S202) and notifies the IT spot terminal device 102 of the read information. The IT spot terminal device 102 temporarily stores the notified device attribute information in a memory 102b in FIG. 1A.

Subsequently, when a log-in request for the IT provider 107 and a predetermined password are input by the operation of the user, the IT spot terminal device 102 sends out the log-in request to the IT provider 107, together with the input password and temporarily stored device attribute information (step S203).

Upon receiving the sent log-in request, password, and device attribute information, the IT provider 107 performs authentication by comparing the received information with the information recorded on the information recording unit 108 (step S204). When the user is specified and authentication is complete, the IT provider 107 notifies the IT spot terminal device 102 of the confirmation of authentication (step S205). Upon receiving the authentication confirmation notification, the IT spot terminal device 102 displays, on the display device 102d, information indicating that the IT spot terminal device 102 has logged in to the IT provider 107.

When the IT spot terminal device 102 logs in to the IT provider 107, the IT spot terminal device 102 can access the personal database and the like in the information recording unit 108. As a consequence, the user can, for example, download individual setting information from the personal database, refer to/edit personal data, and refer to/transmit/receive e-mail by operating the IT spot terminal device 102. In addition, the user can browse Web pages by using the IT spot terminal device 102.

Since the cellular phone connection unit 103 has a cellular phone charging function, the cellular phone 104 is charged while the user operates the IT spot terminal device 102.

In addition, various kinds of data on the Internet 105 can be transferred to the cellular phone 104 through the cellular phone connection unit 103 and IT spot terminal device 102. Likewise, data recorded on the cellular phone 104 can be sent out to the Internet 105.

The cellular phone 104 can access the Internet 105 through the cellular phone network 106. In this case, the user uses the input function of the cellular phone 104, resulting in a deterioration in operability. In addition, in this case, access to the Internet 105 is limited to the communication speed of the cellular phone 104.

An example of how to connect to the cellular phone network 106 by using the IT spot terminal device 102 will be described next with reference to the flowchart of FIG. 3.

When the user who owns the cellular phone 104 mounts the cellular phone 104 on the cellular phone connection unit 103 (step S301), the cellular phone connection unit 103 reads the identification information set (recorded) in the cellular phone 104 from the mounted cellular phone 104 (step S302), and notifies the IT spot terminal device 102 of the identification information. The IT spot terminal device 102 temporarily stores the notified identification information in the memory 102b.

When a log-in request and predetermined password for the cellular phone network 106 are input afterward by the operation of the user, the IT spot terminal device 102 sends out the log-in request to the cellular phone network 106, together with the input password and the identification information temporarily stored in the memory 102b (step S303). Upon receiving the sent log-in request, password, and identification information, the cellular phone network 106 performs authentication by using the received information, and notifies the IT spot terminal device 102 of the confirmation of authentication (step S304).

Upon receiving the confirmation notification of authentication, the IT spot terminal device 102 displays, on the display device 102d, information indicating that the IT spot terminal device 102 has been connected to the cellular phone network 106.

When the IT spot terminal device 102 logs in to the cellular phone network 106, the IT spot terminal device 102 can receive various services through the cellular phone network 106. In addition, the user can browse Web pages by using the IT spot terminal device 102.

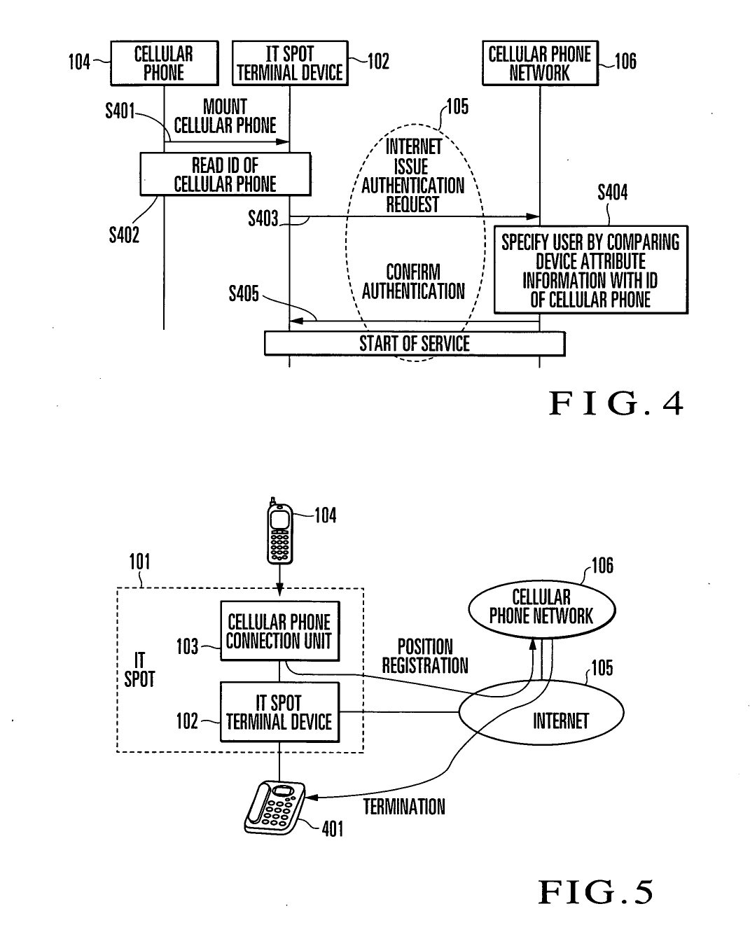

Another example of how to connect to the cellular phone network 106 by using the IT spot terminal device 102 will be described next with reference to the flowchart of FIG. 4. The following is a case wherein the cellular phone 104 has a noncontact IC card function called FeliCa.

When the user who owns the cellular phone 104 mounts the cellular phone 104 on the cellular phone connection unit 103 (step S401), the cellular phone connection unit 103 reads the device attribute information (FeliCa information) held by the FeliCa function from the cellular phone 104 (step S402), and notifies the IT spot terminal device 102 of the information. The IT spot terminal device 102 temporarily stores the notified FeliCa information in the memory 102b.

When a log-in request for the cellular phone network 106 and predetermined password are input afterward by the operation of the user, the IT spot terminal device 102 sends out the log-in request to the cellular phone network 106, together with the FeliCa information temporarily stored in the memory 102b (step S403). Upon receiving the sent log-in request, password, and FeliCa information, the cellular phone network 106 performs authentication by using the received information (step S404). The cellular phone network 106 includes a database for specifying cellular phones and a database for specifying FeliCa information, and performs the above authentication by referring to these databases.

When the user is specified and authentication is completed by the above authentication processing, the cellular phone network 106 notifies the IT spot terminal device 102 of the confirmation of authentication (step S405).

Upon receiving the confirmation notification of authentication, the IT spot terminal device 102 displays, on the display device 102d, information indicating that the IT spot terminal device 102 has been connected to the cellular phone network 106.

When the IT spot terminal device 102 logs in to the cellular phone network 106, the IT spot terminal device 102 can receive various services through the cellular phone network 106. In addition, the user can browse Web pages by using the IT spot terminal device 102.

Furthermore, as shown in FIG. 5, a fixed telephone set 401 may be connected to the IT spot terminal device 102.

As described above, when the IT spot terminal device 102 is connected to the cellular phone network 106 through the Internet 105 upon authentication using the cellular phone 104, a call to the cellular phone 104 (the telephone number of the cellular phone 104) is terminated by the fixed telephone set 401.

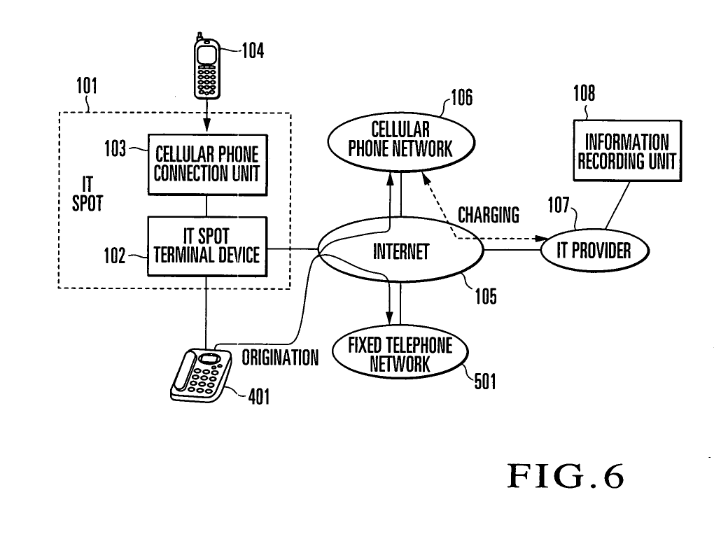

As shown in FIG. 6, the fixed telephone set 401 can originate a call to the cellular phone network 106 or a fixed telephone network 501. In this case, a telephone rate is charged by the IT provider 107 or the carrier of the cellular phone network 106 with which the user is under contract. It suffices for the user to pay the above telephone rate as an Internet connection fee and cellular phone rate.

As described above, the IT spot terminal device 102 is, for example, a computer, and includes the CPU 102a, the memory 102b, the display device 102d, the input device 102e such as a keyboard or mouse, the voice output device 102f, a network connection device, and the like. The IT spot terminal device 102 implements each function described above by making the CPU 102a execute a corresponding program recorded on the memory 102b.

The above description has exemplified the IT provider 107. However, the present invention is not limited to this, and may be applied to a server provided for a local area network provided in a business organization. In this case, the server includes an information recording unit, on which individual information and the like are recorded.

As has been described above, according to the present invention, the IT terminal device connected to the Internet reads out device attribute information containing individual identification information of a cellular phone, and uses the read device attribute information as authentication information. This makes it possible to obtain an excellent effect, i.e., realizing an environment, in an unevenly distributed state, which allows connection to the Internet by using a cellular phone with better operability.

According to the present invention, there is provided a program for causing a computer to execute a process of reading out device attribute information containing the individual identification information of a cellular phone from the cellular phone which is inserted in the fitting portion of a cellular phone connection unit in/from which the cellular phone can be inserted/removed, and a process of sending out the read device attribute information as authentication information to the Internet.

In the above embodiment, device attribute information may be read out from the storage unit of the cellular phone. In addition, the information acquired by the IT terminal device through the Internet may be recorded on the storage unit of the cellular phone connected to the cellular phone connection unit.

In the above embodiment, the IT spot terminal device may be connected to a digital network such as a LAN in a company or private LAN or a digital data network. In this case, the IT spot terminal device 102 incorporates a protocol for connection to the LAN as well as a protocol for connection to the Internet.

What is claimed is:

1. A network authentication apparatus comprising:
a cellular phone connection unit which includes a fitting portion in/from which a cellular phone can be inserted/removed; and
an IT terminal device which is connected to said cellular phone connection unit, includes a memory, and is connected to a digital network,
wherein said IT terminal device reads out device attribute information containing individual identification information of a cellular phone from the cellular phone connected to said cellular phone connection unit, and sends out the readout device attribute information as authentication information to the digital network.

2. An apparatus according to claim 1, wherein the device attribute information comprises device attribute information read out from a memory which the cellular phone includes.

3. An apparatus according to claim 2, wherein the device attribute information comprises information which records the information, acquired by said IT terminal device through the digital network, on the memory of the cellular phone connected to said cellular phone connection unit.

4. An apparatus according to claim 1, further comprising a fixed telephone set connected to said IT terminal device.

5. An apparatus according to claim 1, wherein said IT terminal device includes a processing device which reads device attribute information from the cellular phone and a memory which stores the device attribute information.

6. A network authentication method comprising:
providing a cellular phone connection unit which includes a fitting portion in/from which a cellular phone can be inserted/removed, and an IT terminal device which is connected to the cellular phone connection unit, includes a memory and an input unit, and is connected to a digital network;
reading out device attribute information containing individual identification information of a cellular phone from the cellular phone connected to the cellular phone connection unit; and
sending out the readout device attribute information as authentication information to the digital network.

7. A method according to claim 6, wherein the device attribute information comprises device attribute information read out from a memory which the cellular phone includes.

8. A method according to claim 7, wherein the device attribute information comprises information which records the information, acquired by the IT terminal device through the digital network, on the memory of the cellular phone connected to the cellular phone connection unit.

9. A program comprising a network authentication program for causing a computer to execute
a process of reading out device attribute information containing individual identification information of a cellular phone from the cellular phone inserted in the fitting portion of a cellular phone connection unit in/from which the cellular phone can be inserted/removed, and
a process of sending out the readout device attribute information as authentication information to the digital network.

10. A network authentication system comprising:
a network authentication apparatus which includes an IT terminal device which has a display unit and an input unit and is connected to a digital network, a cellular phone connection unit which is connected to the IT terminal device, includes a fitting portion in/from which a cellular phone can be inserted/removed, and connects the cellular phone inserted in the fitting portion to the IT terminal device, and a fixed telephone set connected to the IT terminal device, the IT terminal device reading out device attribute information containing individual identification information of the cellular phone from the cellular phone connected to the cellular phone connection unit and sending out the readout device attribute information as authentication information to the digital network; and
a provider connected through the digital network and including an information storage unit which includes an individual information recording database and is connected to said network authentication apparatus.

11. A network authentication system comprising:
a network authentication apparatus which includes an IT terminal device which has a display unit and an input unit and is connected to a digital network, a cellular phone connection unit which is connected to the IT terminal device, includes a fitting portion in/from which a cellular phone can be inserted/removed, and connects the cellular phone inserted in the fitting portion to the IT terminal device, and a fixed telephone set connected to the IT terminal device, the IT terminal device reading out device attribute information containing individual identification information of the cellular phone from the cellular phone connected to the cellular phone connection unit and sending out the readout device attribute information as authentication information to the digital network; and
a cellular phone network and a fixed telephone network which are connected to the digital network.

12. A network authentication system comprising:
a network authentication apparatus which includes an IT terminal device which has a display unit and an input unit and is connected to a digital network, a cellular phone connection unit which is connected to the IT terminal device, includes a fitting portion in/from which a cellular phone can be inserted/removed, and connects the cellular phone inserted in the fitting portion to the IT terminal device, and a fixed telephone set connected to the IT terminal device, the IT terminal device reading out device attribute information containing individual identification information of the cellular phone from the cellular phone connected to the cellular phone connection unit and sending out the readout device attribute information as authentication information to the digital network; and
a fixed telephone network connected to the IT terminal device.

13. A network authentication system comprising:
a network authentication apparatus which includes a cellular phone connection unit including a fitting portion in/from which a cellular phone can be inserted/removed, and an IT terminal device which is connected to said cellular phone connection unit, includes a display unit and an input unit, and is connected to a digital network, the IT terminal device reading out device attribute information containing individual identification information of a cellular phone from the cellular phone connected to the cellular phone connection unit, and sending out the readout device attribute information as authentication information to the digital network;
a provider connected through the digital network and including an information storage unit which includes an individual information recording database and is connected to said network authentication apparatus; and
a fixed telephone network connected to the network.
